(19) United States
(12) Patent Application Publication
(10) Pub. No.: US 2024/0316564 A1
(43) Pub. Date: Sep. 26, 2024

(54) OPTIMIZED CRYOGENIC TRANSFER SYSTEM FOR MACRO-MOLECULAR CRYSTALLOGRAPHY APPARATUS AND METHOD

(71) Applicant: RIGAKU AMERICAS CORPORATION, The Woodlands, TX (US)

(72) Inventors: Michael HICKMAN, New Waverly, TX (US); John Dzung Tien TRUONG, Houston, TX (US); Thomas Leon HENDRIXSON, Conroe, TX (US); Kevin Douglas LA BLUE, Willis, TX (US); Joseph David FERRARA, The Woodlands, TX (US)

(73) Assignee: RIGAKU AMERICAS CORPORATION, The Woodlands, TX (US)

(21) Appl. No.: 18/187,824

(22) Filed: Mar. 22, 2023

(51) Int. Cl. B01L 9/06; B01L 7/00; B01L 9/02

(52) U.S. Cl. CPC B01L 9/06; B01L 7/50; B01L 9/02; B01L 2300/1894

(57) ABSTRACT

An analysis system assembly and method for analyzing a plurality of samples and handling the cryogenically cooled samples from a shipping dewar into a position for analysis by an x-ray based analysis system. The system and method include a basket component containing a plurality of sample magazines each containing a plurality of samples, all covered by a volume of cryogenic liquid. The basket is transported from the shipping dewar to a transfer dewar. Cover components of the magazines are removed while the basket and magazines are submerged in a cryogenic liquid of the transfer dewar. The basket is removed from the transfer dewar and placed into a staging dewar of the analysis system. A robotic manipulator of the analysis system can then locate and transport individual samples to a sample stage of the analysis system.

### BACKGROUND

Various scientific analysis systems of substances such as crystals including pharmaceutical compositions are based on exposing samples to x-ray radiation producing x-ray diffraction patterns which are characteristic of the molecular makeup of the sample crystal (X-ray crystallography). The systems used to analyze the diffraction patterns are known as difractometers. While such basic analysis system techniques are well known, users of such systems are seeking to enhance the efficiency of analyzing multiple samples. This is especially true since the handling time for samples increases the dedicated operating time of the associated synchrotron or other x-ray sources. Moreover, there is a constant need to enhance the efficiency of analysis system processes including those in this field.

### SUMMARY

The applicant has a long history of offering devices in the above described area including the currently available “ACTOR”™ (“Automated Crystal Transport Orientation and Retrieval”) robot system. In one implementation, crystal samples are deposited onto sample pins placed into magazines containing multiple sample pins, which are transported in a shipping dewar to a location having the analysis system. An operator manually transfers a magazine individually from the shipping dewar into a transfer dewar which is moved into the “hutch” area containing the ACTOR (or other) system. The sample magazine is thereafter moved manually into the ACTOR dewar. An automated system removes sample pins from the magazine for analysis. The ACTOR system is an integrated analysis system including a pick and place robot arm with an end effector for grasping sample pins and other purposes, a sample analysis stage, an x-ray source, x-ray detection imaging systems and associated computer operating and display hardware and software. The system operates effectively although considerable operator involvement is necessary. Applicants seek to reduce the analysis time for multiple samples by increasing the efficiency of sample workflow for analysis. Presently, individual magazines are handled separately. In accordance with the apparatus and methods of the present invention, a batch processing approach is utilized in which multiple magazines (in an exemplary embodiment-seven magazines) are loaded into a sample basket which is transferred into the ACTOR (or other system) enabling the robot to handle samples from multiple magazines in a single analysis sequence. Related method steps are utilized using the sample basket for batch processing.

### BRIEF DESCRIPTION OF THE DRAWINGS

FIG. 1 shows a cart for transporting a shipping dewar containing sample magazines for analysis and further showing a transfer dewar for receiving the magazines.

FIG. 2 shows multiple magazines being removed from the shipping dewar.

FIGS. 3 and 4 shows individual magazines being transported into the sample basket in a transfer dewar.

FIG. 5 shows a completion of the step of loading magazines into the basket.

FIG. 6 shows the sample cart being moved into position adjacent to the ACTOR system hutch.

FIG. 7 shows the basket ready for transport of the individual sample magazines.

FIGS. 8 and 9 show the magazine covers being removed.

FIG. 10 shows manual operated handles being locked onto transportation pins of the basket.

FIG. 11 shows the basket being removed from the transfer dewar

FIG. 12 shows the basket being removed from the transfer dewar and being placed into the ACTOR's staging dewar.

FIG. 13 shows the transport handles removed from the basket.

FIGS. 14 and 15 are detailed views of the basket shown with magazines in place.

FIGS. 16 and 17 are plan views of the magazine base.

FIG. 18 is a side view of the magazine base.

FIG. 19 is a cross-sectional view of the magazine base taken along line 19-19 of FIG. 16.

FIG. 20 is an enlarged view of the center portion of the magazine base.

FIG. 21 is a cut away enlargement of a perimeter portion of the magazine base.

FIG. 22 is a prospective view of the sample pin.

### DETAILED DESCRIPTION

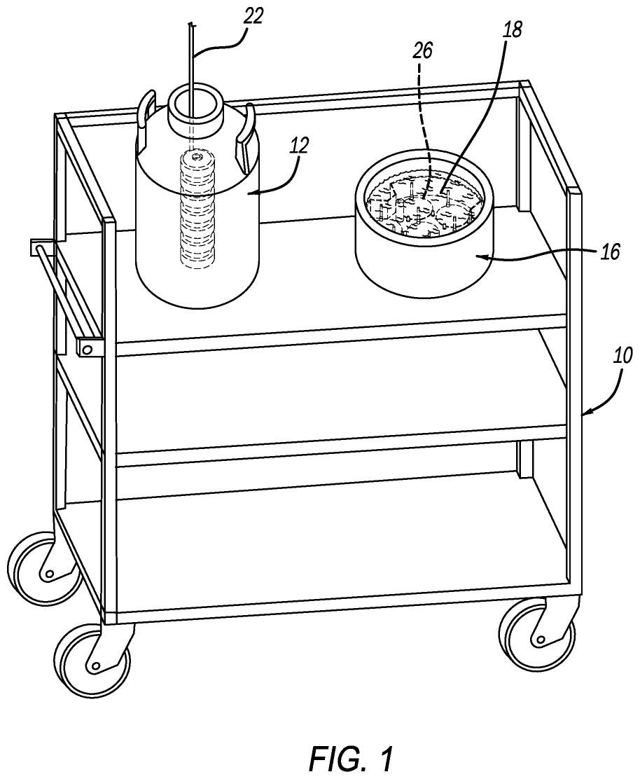

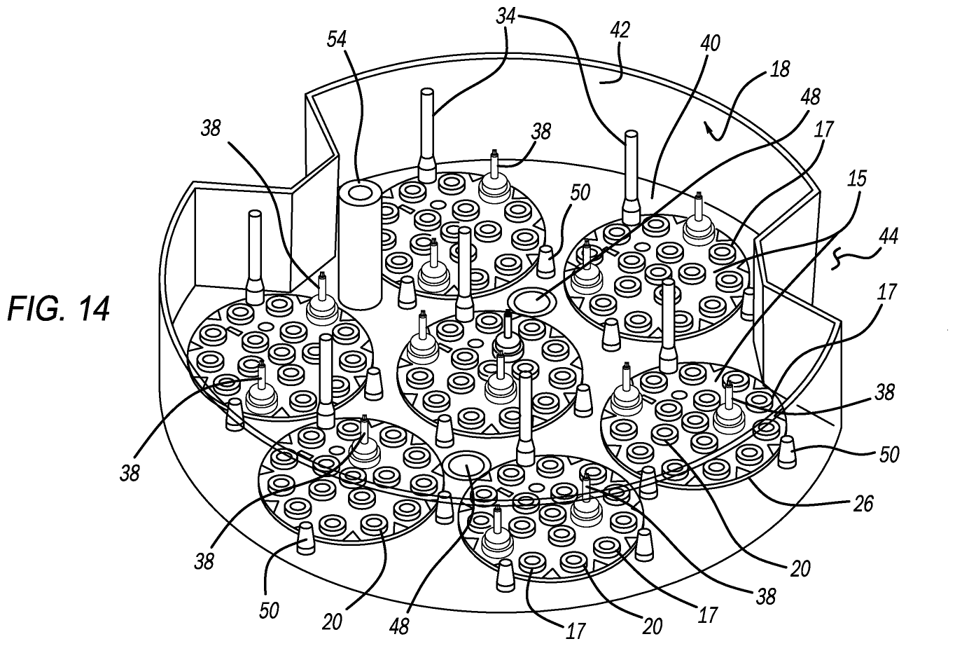

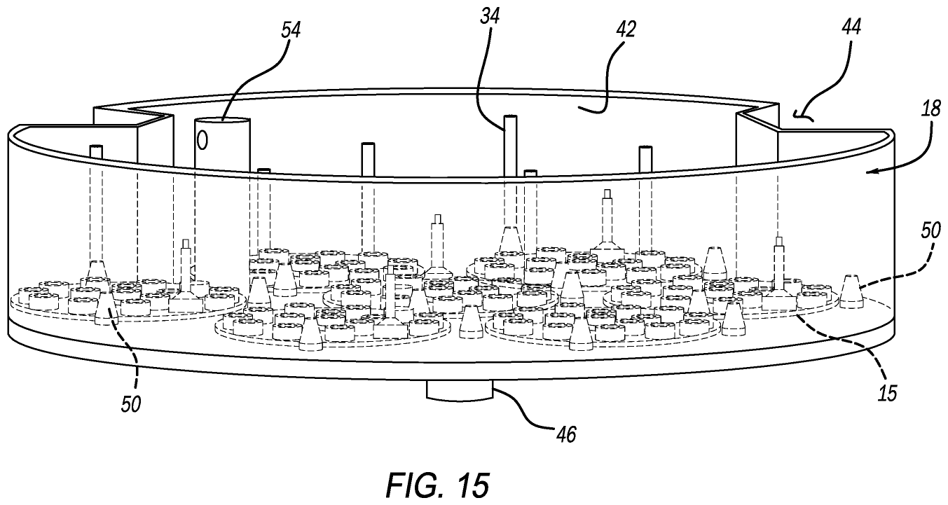

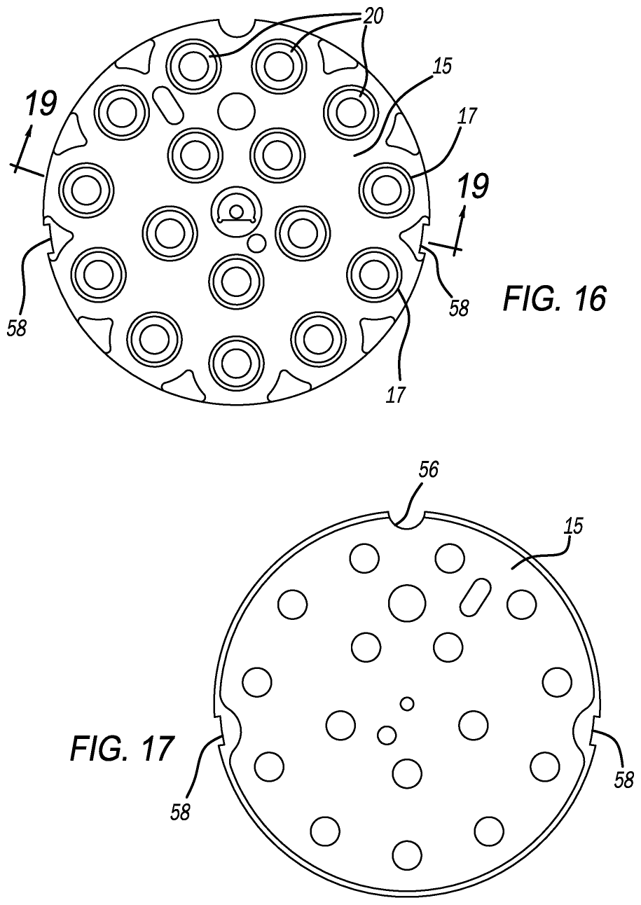

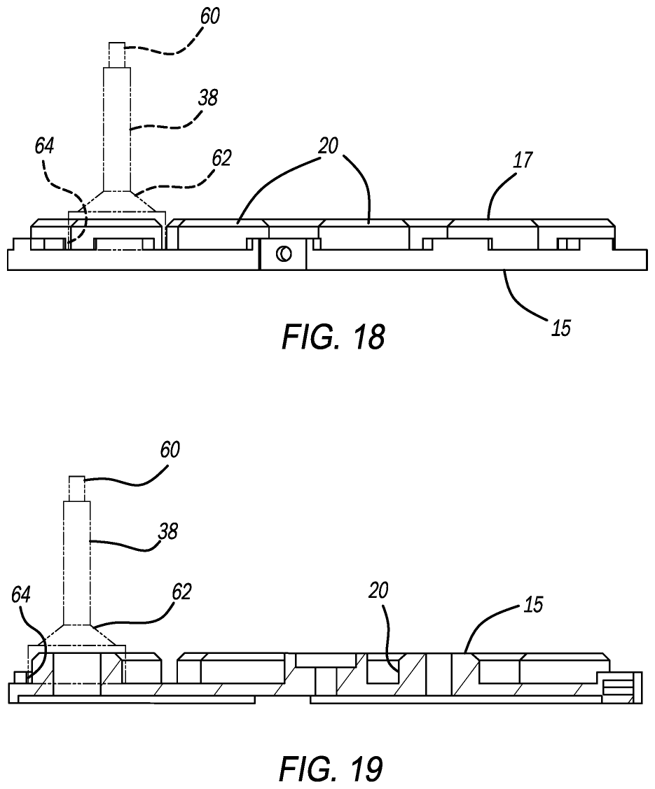

The process and components of the system of this invention are illustrated in appended FIGS. 1-22.

FIG. 1 illustrates transportation cart 10 supporting shipping dewar 12 which contains a number of sample magazines 14, and transfer dewar 16 containing sample basket 18. Dewars 12 and 16 are partially filled with a cryogenic liquid such as liquid Nitrogen (LN2). Magazines 14 contained within shipping dewar 12 are pre-loaded with sample pins 38 and crystal samples on their tips which are prepared in a prior operation. Each magazine 14 provides, in an exemplary embodiment, sixteen receiving pads 20, and thus provides sixteen discrete samples for analysis. Cart 10 can be readily moved about the facility having the ACTOR (or other analysis) system.

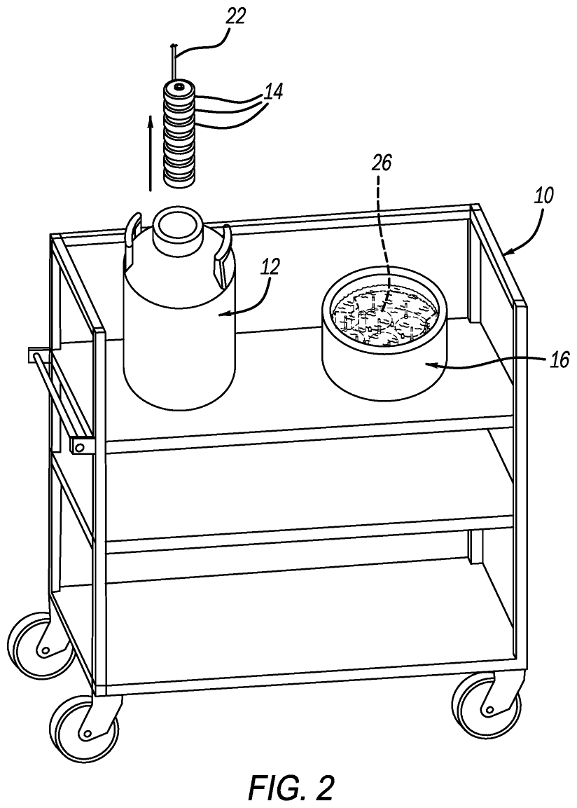

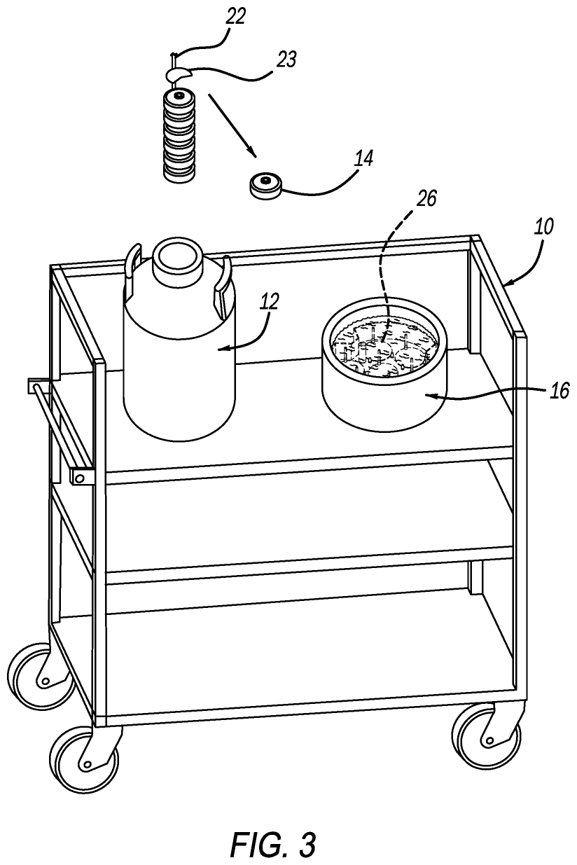

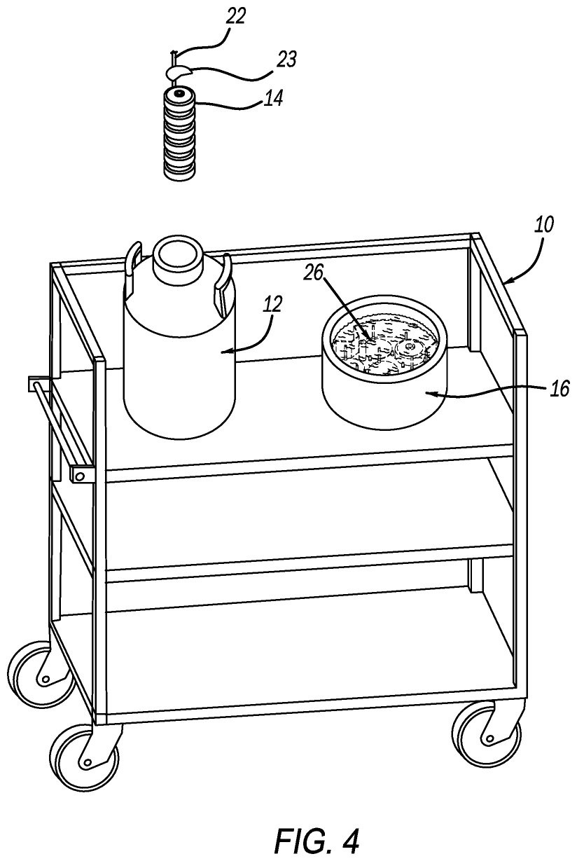

FIG. 2 shows a stack of sample magazines 14 being removed from shipping dewar 12 using lifting arm 22 which has individual support plates 23 for each of the magazines 14. FIGS. 3 and 4 show individual magazines 14 being transported into position from plates 23 onto associated holding pads 26 of each magazine 14 set in transfer dewar 16. In this exemplary embodiment sample basket 18 accommodates seven magazines 14, thus enabling up to one hundred twelve samples to be readied for analysis. FIG. 5 shows this transport process being completed with each magazine 14 in position within basket 18. FIGS. 1-6, and 7-10 show transfer dewar 16 having a pool of LN2 covering basket 18 and sample magazines 14 to maintain the samples at the desired cryogenic temperature.

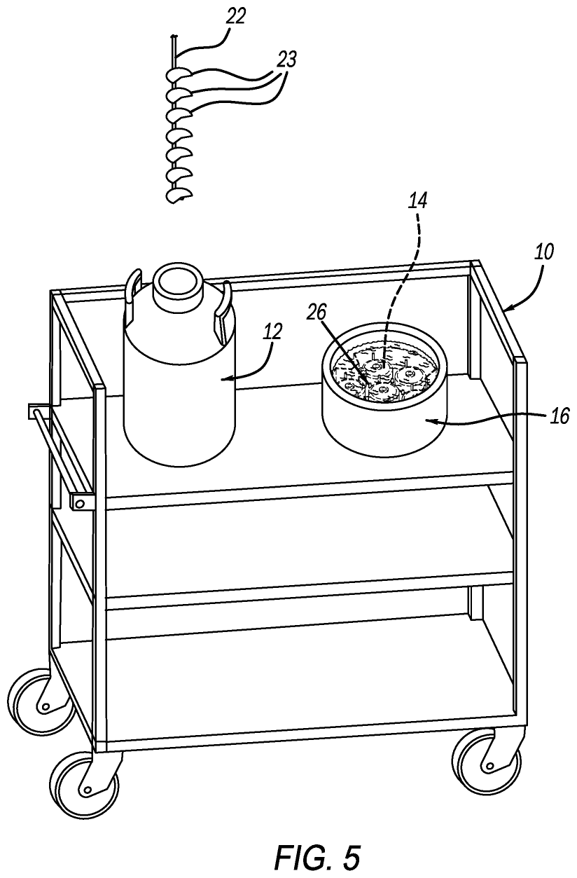

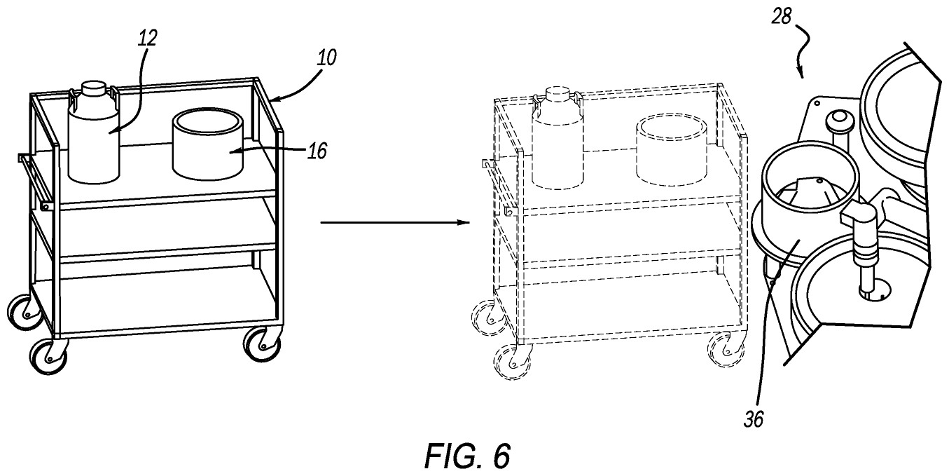

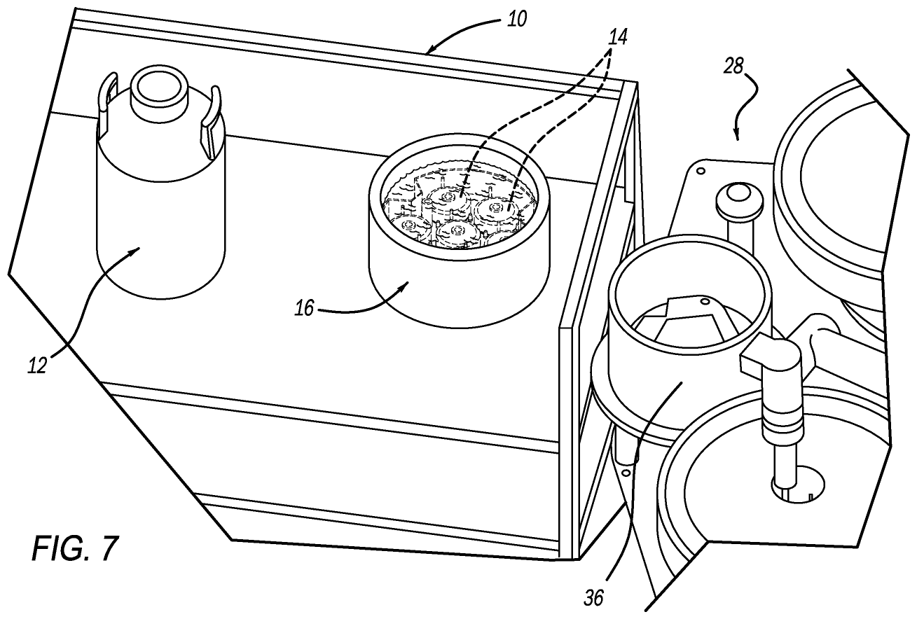

FIGS. 6 and 7 show cart 10 being moved into position adjacent to ACTOR system 28 (the hutch enclosure). Next, covers 30 of each of magazines 14 are removed manually (using an appropriate handling tool) and placed aside on cart 10 as depicted in FIGS. 8 and 9. Details of sample magazines 14 begin to be shown with FIG. 8. Magazines 14 include base 15 which has a number of receiving pad features 20 for receiving sample pins bases 62. Preferably, these features are in the form of circular magnets 17 fixed to base 15. Covers 30 interact with base 15 using the spring-loaded detent elements which normally hold covers 30 in position affixed to base 15, but which can be removed as shown in FIG. 8.

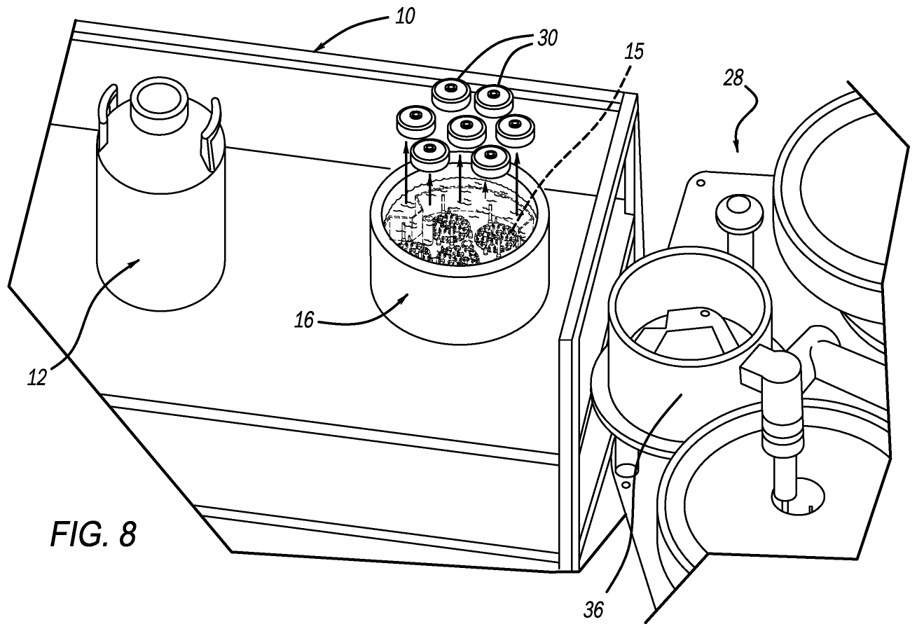

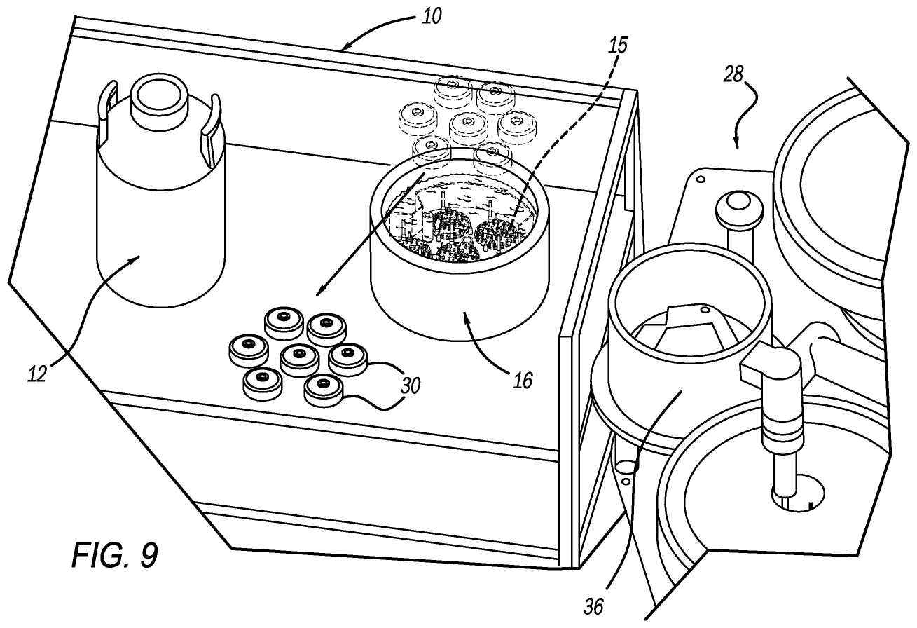

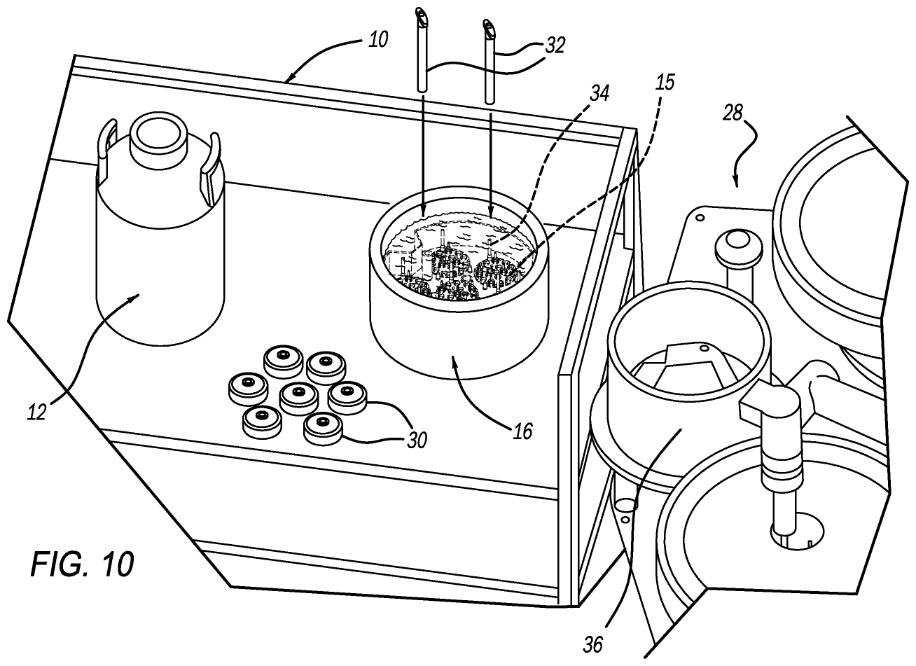

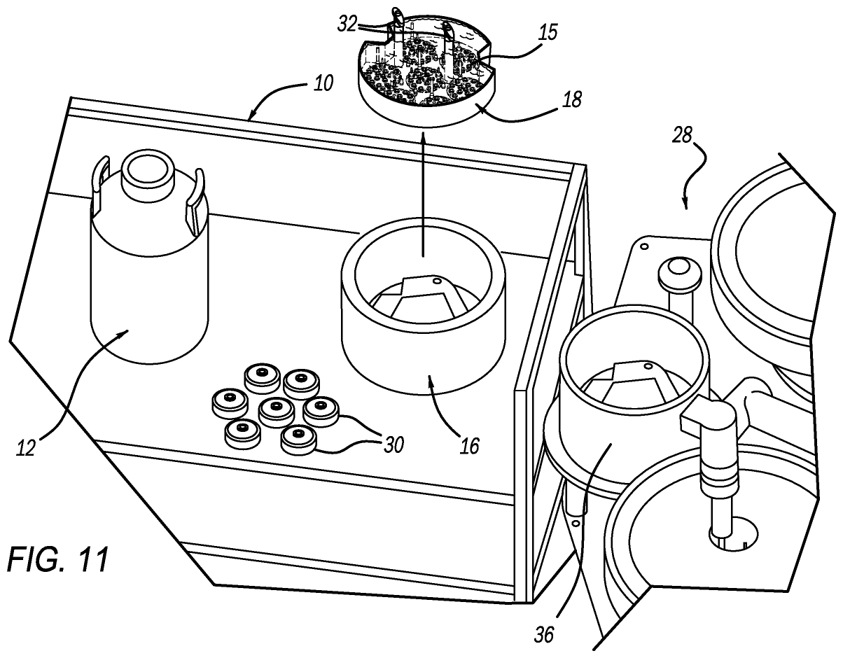

FIG. 10 shows manually operated handles 32 being latched onto upstanding handling pins 34 of basket 18 to enable movement of baskets 18, as illustrated in FIG. 11. Basket 18 is at least partially filled with LN2 to maintain the samples at a desired cryogenic temperature. Next, basket 18 is manually transported into the ACTOR's staging dewar 36. It is a necessary to accurately locate basket 18 within staging dewar 36 to enable the robotic manipulator arm of the ACTOR system 28 to engage with individual sample pin bases 62 to place the pins and the associated samples in position for analysis. FIGS. 12 and 13 show this process being completed.

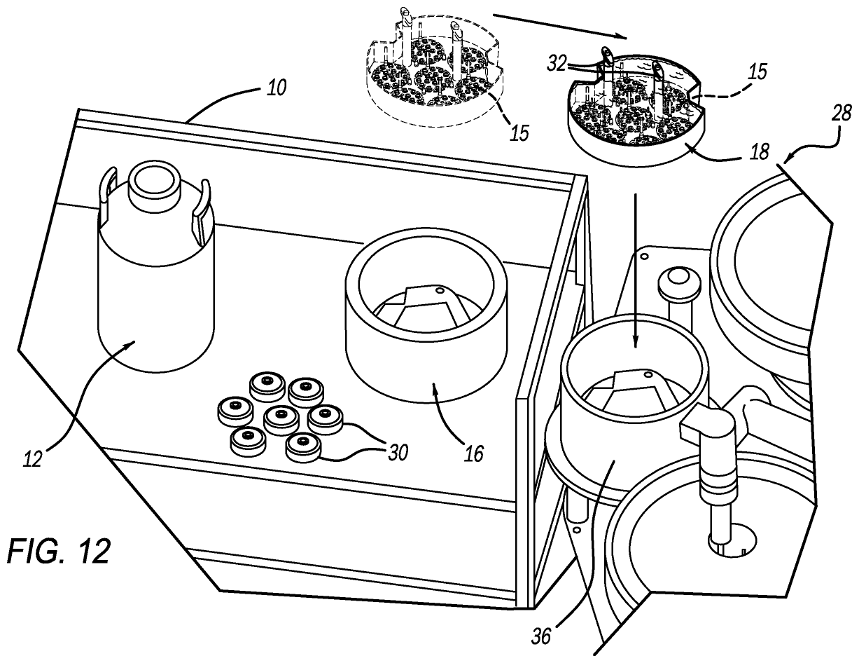

FIGS. 14 and 15 show details of basket 18 which forms a flat base 40 and an upstanding wall 42 having indentations 44 which provide clearance for components of the ACTOR system 28 such as, for example, a liquid nitrogen sensor and filling spigots (not shown). Base surface 40 forms on its bottom surface projecting post 46 and one or more apertures 48 which interact with locating features of ACTOR system 28, enabling the translated and rotational indexed position of magazines 14 to be establish accurately with respect to the mating locating structures of ACTOR system 28. The upper surface of base 40 features a series of relatively longer and shorter projecting pins used for locating each of sample magazines 14 accurately with respect to the base 40. Longer pins 34 interact with a cut out notch 56 formed in the magazine bases 15, and shorter pins 50 engage with the outer perimeter of magazine bases 15. Robotic sensor pin 54 is provided as a datum surface which is detected or touched by the robot arm (not shown) of the ACTOR system 28 to provide a reference position for pick and place steps to be undertaken by the robotic system.

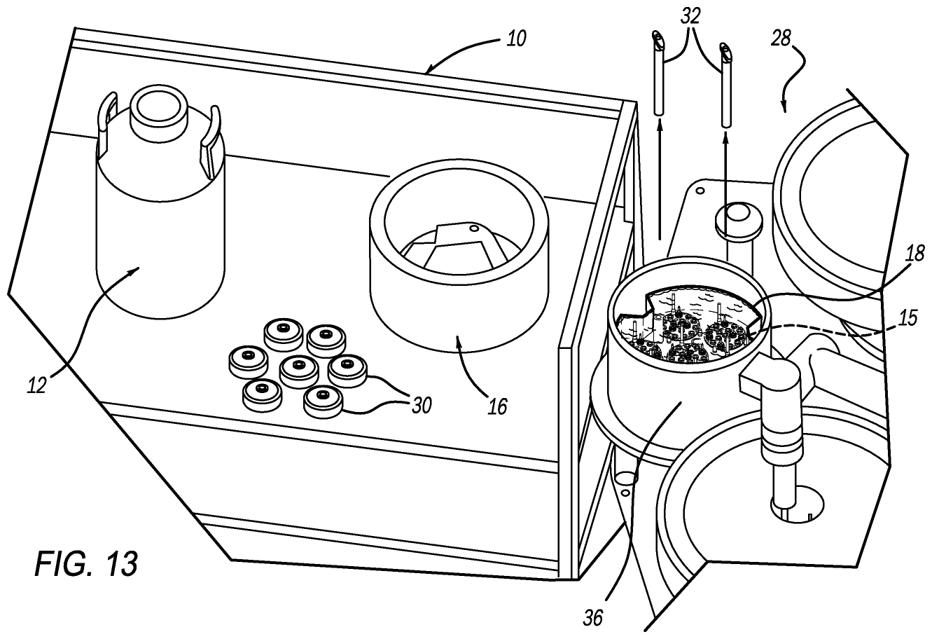

Details of magazine bases 15 are shown in FIGS. 16-21. As mentioned previously, circular magnets 17 are placed on the top surface of the magazine bases 15. Perimeter slots 58 are provided for engaging with latching features of magazine covers 30 and notch 56 engages with handling pins 34.

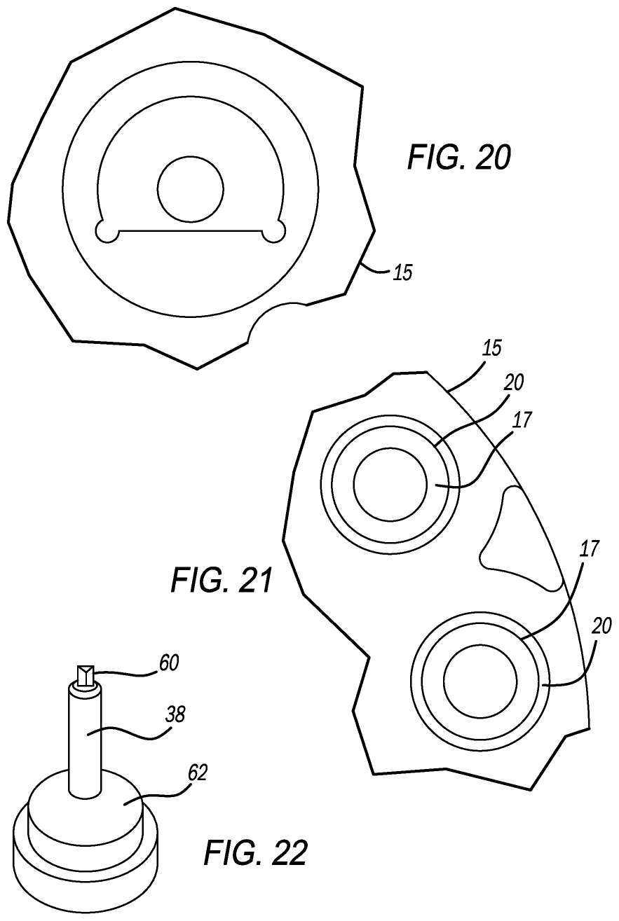

Sample pin 38 is shown in FIG. 22 including crystal sample 60 mounted at its distal and. Base structure 62 forms and underside with a concave socket 64 closely receiving magazine base magnets 17.

While the above description constitutes the preferred embodiment of the present invention, it will be appreciated that the invention is susceptible to modification, variation and change without departing from the proper scope and fair meaning of the accompanying claims.

What is claimed is:

1. A process for handling samples for analysis by an x-ray-based analysis system having a staging dewar and a robotic manipulator, the samples of a type required to be maintained at a cryogenic temperature during handling, comprising the steps of;
providing a first plurality of sample magazines, the sample magazines each having a base and a removable cover, the base having features for receiving a second plurality of sample pins, the sample pins removably affixed to the magazine base,
the first plurality of sample magazines each having the second plurality of sample pins affixed to the magazine base,
providing a shipping dewar for containing the first plurality of sample magazines containing the second plurality of sample pins,
providing a transfer dewar,
providing a lifting arm for supporting and allowing the removal of the first plurality of sample magazines from the shipping dewar to the transfer dewar,
providing a sample basket for receiving the first plurality of sample magazines,
transferring the first plurality of sample magazines from the shipping dewar to the transfer dewar and into the sample basket within the transfer dewar,
transporting the transfer dewar to a position adjacent to the analysis system,
removing the covers from the magazines, and
removing the basket containing the second plurality of magazines and sample pins from the transfer dewar to the staging dewar.

2. The process in accordance with claim 1 further comprising wherein the first plurality is seven.

3. The process in accordance with the claim 1 further comprising wherein the second plurality is sixteen.

4. The process in accordance with the claim 1 further comprising the step of providing a transportation cart for supporting the shipping dewar and the transfer dewar together during the transporting step.

5. The process in accordance with the claim 1 further comprising the step of fixing the position of each of the magazines with respect to the basket during the transferring step.

6. The process in accordance with the claim 1 further comprising the step of providing the sample basket having a base and an upstanding perimeter wall adapted for containing a cryogenic liquid, the sample basket a containing the cryogenic liquid at least during the removing the basket step.

7. A sample basket for an assembly for handling samples for analysis by an x-ray-based analysis system having a robotic manipulator, the samples of a type required to be maintained at a cryogenic temperature during handling, the assembly adapted to be used with a first plurality of sample magazines each having a magazine base and a removable cover, the magazine base having features for receiving a second plurality of sample pins, the sample pins being removably affixed to the magazine base, the assembly adapted for enabling the first plurality of magazines containing the second plurality of sample pins to be contained in a shipping dewar and transferred to a transfer dewar and thereafter to a staging dewar of the analysis system, comprising;
the sample basket adapted for receiving the first plurality of the sample magazines, the sample basket forming a basket base and an upstanding perimeter wall cooperating for containing a level of a cryogenic liquid submerging the sample magazines, the basket base forming first locating features for locating each of the first plurality of magazines onto the basket base in an established position, the sample basket having second locating features for enabling the orientation of the basket to be fixed with respect to the analysis system.

8. The sample basket in accordance with claim 7 further comprising, wherein the basket base forms an upper surface receiving the magazines and a bottom surface, the upper surface forming the first locating features in the form of a plurality of locating pins interacting with the magazine base to locate each of the magazine bases with respect to the basket base upper surface.

9. The sample basket in accordance with claim 8 further comprising, wherein the basket bottom surface forms features interacting with a component of the analysis system to locate the basket with respect to the analysis system.

10. The sample basket in accordance with claim 8, wherein the basket further comprises an upstanding sensor pin affixed to the basket base upper surface for interacting with the robot manipulator.

11. The sample basket in accordance with claim 7 further comprising, wherein the plurality of locating pins is formed by a first set of pins and a second set of pins, the first set of pins being relatively longer than the second set of pins, the first set of pins interacting with a notch formed by the magazine base and the first and second sets of pins engaged with the outer perimeter of the magazine base to locate the magazines.

12. The sample basket in accordance with claim 11 further comprising the first set of pins adapted to be engaged by a handle removable affixed to the first set of pins for enabling transporting of the basket.

13. The sample basket in accordance with claim 7 further comprising the first plurality equal to seven.
